(19) United States
(12) Patent Application Publication
(10) Pub. No.: US 2012/0191876 A1
(43) Pub. Date: Jul. 26, 2012

(54) METHOD AND SYSTEM FOR POLICY BASED TRANSCODING BROKERING

(75) Inventors: Drew Johnson, San Carlos, CA (US); Indranath Ghosh, Santa Clara, CA (US); John Nguyen, Milpitas, CA (US); Anil Bhikuayya Jangam, Maharashtra (IN)

(73) Assignee: Openwave Systems Inc., Redwood City, CA (US)

(21) Appl. No.: 13/010,751

(22) Filed: Jan. 20, 2011

(51) Int. Cl. G06F 15/16

(52) U.S. Cl. 709/246

(57) ABSTRACT

A method and system for managing the delivery of content over a content network is described. In one embodiment, a method for managing the delivery of content over a content network involves maintaining a transcoding brokerage policy for a transcoding system that includes multiple transcoding engines, where the transcoding brokerage policy defines rules for selecting the transcoding engines, receiving a request for a content element that is stored at a content source, selecting one of the transcoding engines to transcode the requested content element according to the transcoding brokerage policy, and causing the requested content element to be transcoded by the selected transcoding engine. Other embodiments are also described.

### BACKGROUND

Content elements, such as video files, are often transcoded before being delivered to an end-user device, such as a desktop computer, a laptop computer, a pad computer, or a smart phone. Specifically, the bit rate of the video files may be adjusted. Additionally, the format of the video files may be converted. For example, before the video files are delivered to a wireless device, the bit rate of the video files can be adjusted and the format of the video files can be converted to account for the physical dimensions and resolution of the display of the wireless device or the codecs supported by the wireless device.

### SUMMARY

A method and system for managing the delivery of content over a content network is described. In one embodiment, a method for managing the delivery of content over a content network involves maintaining a transcoding brokerage policy for a transcoding system that includes multiple transcoding engines, where the transcoding brokerage policy defines rules for selecting the transcoding engines, receiving a request for a content element that is stored at a content source, selecting one of the transcoding engines to transcode the requested content element according to the transcoding brokerage policy, and causing the requested content element to be transcoded by the selected transcoding engine. Other embodiments are also described.

In another embodiment, a method for managing the delivery of content over a content network is described. The method for managing the delivery of content over a content network involves maintaining a transcoding brokerage policy for a transcoding system that includes multiple transcoding engines, where the transcoding brokerage policy defines rules for selecting the transcoding engines, receiving a request for a video content element that is stored at a content source, selecting one of the transcoding engines to transcode the requested video content element according to the transcoding brokerage policy, and causing the requested video content element to be transcoded by the selected transcoding engine. Maintaining the transcoding brokerage policy includes setting the transcoding brokerage policy based on the state of the transcoding system and adjusting the transcoding brokerage policy in response to a change in the state of the transcoding system, where the change in the state of the transcoding system is communicated from at least one of the transcoding engines as feedback information. Other embodiments of a method are also described.

Embodiments of a transcoding broker for managing the delivery of content over a content network are also described. In one embodiment, a transcoding broker for managing the delivery of content over a content network includes a transcoding engine proxy configured to receive a request for a content element that is stored at a content source and a service broker configured to: maintain a transcoding brokerage policy for a transcoding system that includes multiple transcoding engines, where the transcoding brokerage policy defines rules for selecting the transcoding engines; and select one of the transcoding engines to transcode the requested content element according to the transcoding brokerage policy. The transcoding engine proxy is further configured to cause the requested content element to be transcoded by the selected transcoding engine. Other embodiments of a transcoding broker for managing the delivery of content over a content network are also described.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic block diagram of one embodiment of a content delivery system.

FIG. 2 depicts an embodiment of the transcoding broker of FIG. 1.

FIG. 3 depicts an embodiment of a hybrid transcoding infrastructure.

FIG. 4 illustrates interactions between the transcoding broker of FIG. 2 and the transcoding system and the content source of FIG. 1.

FIG. 5 illustrates an example of a real-time operation of the content delivery system of FIG. 4.

FIG. 6 illustrates an example of an offline operation of the content delivery system of FIG. 4.

FIG. 7 depicts a computer that includes a processor, memory, and a communications interface.

FIG. 8 is a process flow diagram of a method for managing the delivery of content over a content network in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment. Rather, language referring to the features and advantages is understood to mean that a specific feature, advantage, or characteristic described in connection with an embodiment is included in at least one embodiment. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment. Thus, the phrases “in one embodiment,” “in an embodiment,” and similar language throughout this specification may, but do not necessarily, all refer to the same embodiment.

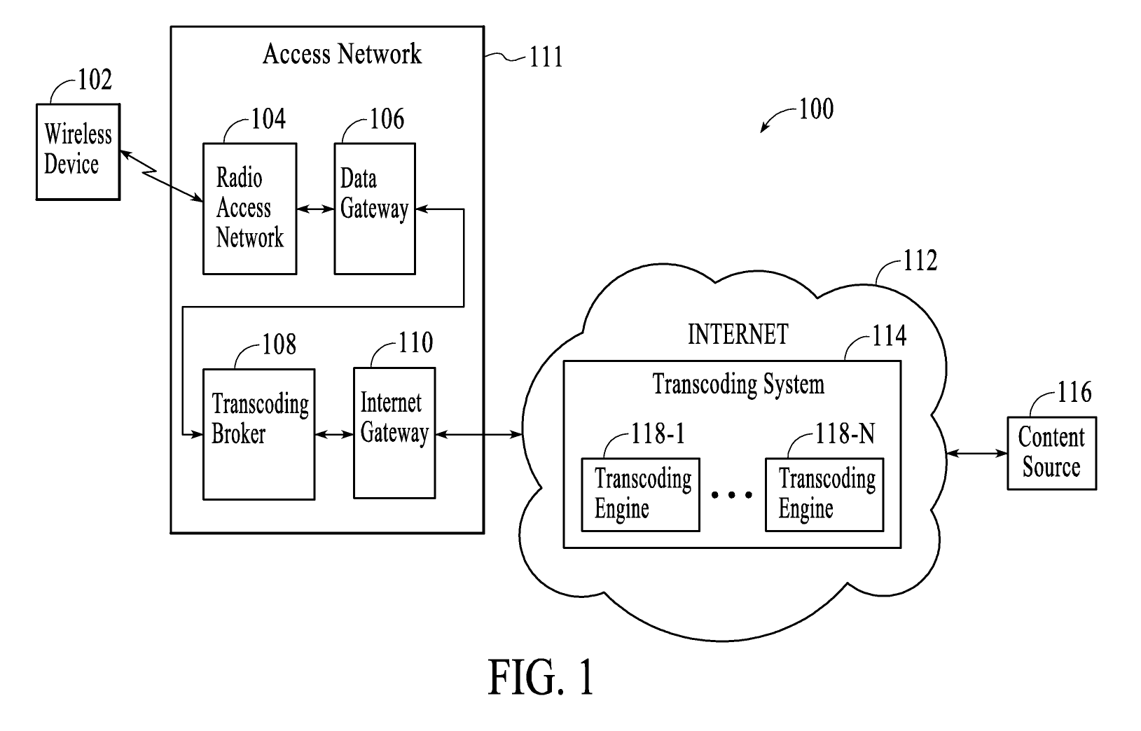

FIG. 1 depicts a schematic block diagram of one embodiment of a content delivery system 100. The content delivery system depicted in FIG. 1 includes a wireless device 102, an access network 111, the Internet 112, and a content source 116. In the embodiment depicted in FIG. 1, the access network includes a radio access network 104, a data gateway 106, a transcoding broker 108, an Internet gateway 110 and the Internet includes a transcoding system 114. The transcoding system includes multiple transcoding engines 118-1 . . . 118-N, where N is an integer that is larger than one. Although the content delivery system is depicted and described with certain components and functionality, other embodiments of the content delivery system may include fewer or more components to implement less or more functionality. For example, the content delivery system may include more than one wireless device, more than one radio access network, more than one data gateway, more than one transcoding broker, more than one Internet gateway, more than one transcoding system, and/or more than one content source.

The wireless device 102 of the content delivery system 100 is typically a handheld wireless device, such as a cell phone, a mobile phone, a smartphone, a pad computer, a Personal Digital Assistant (PDA), a handheld gaming device etc, which can wirelessly communicate using radio frequency (RF) communications signals. The wireless device can support various different RF communications protocols, including without limitation, Global System for Mobile communications (GSM), Universal Mobile Telecommunications System (UMTS), Code Division Multiple Access (CDMA), Worldwide Interoperability for Microwave Access (WiMax) and communications protocols as defined by the 3^{rd} Generation Partnership Project (3GPP) or the 3^{rd} Generation Partnership Project 2 (3GPP2), 4G Long Term Evolution (LTE) and IEEE 802.16 standards bodies. Although some wireless communications protocols are identified herein, it should be understood that the present disclosure is not limited to the cited wireless communications protocols. The wireless device is configured to request content from the content source 116 on behalf of a user and to render received content for presenting to the user. The user may be a single person, multiple persons, other entity or entities.

In the embodiment depicted in FIG. 1, the access network 111 provides access to the Internet 112. Typical access networks include wireless service provider networks (e.g. that offer 3G, 4G and/or WiFi access) and ISPs (e.g., that offer dial-up, DSL, and/or cable modem access). A private enterprise network can also serve as an access network if client devices within the private enterprise network can access the Internet through the private enterprise network. The access network may be administered by a single entity or different entities. For example, the access network may be managed by a single Internet service provider (ISP), a wireless service provider, or a private enterprise.

The radio access network 104 of the access network 111 is configured to facilitate radio communications between the wireless device 102 and a core network that includes the data gateway 106, the transcoding broker 108, the Internet gateway 110, the Internet 112 that includes the transcoding system 114, and the content source 116. In an embodiment, the radio access network includes one or more base stations to facilitate communications among wireless devices that are within a communications range of the base stations. Each base station has at least one RF transceiver and the base stations communicate with the wireless devices using RF communications signals. The radio access network facilitates network communications among multiple wireless devices within the same radio access network and between wireless devices in other radio access networks and provides interfaces to facilitate communications with other entities, such as a Public Switched Telephone Network (PSTN), a Wide Area Network (WAN), the Internet, Internet servers, hosts, etc., which are outside of the radio access network. In an embodiment, the network elements depicted in FIG. 1 are part of a wireless network that is operated by a single wireless service provider.

Data signals communicated between the wireless device 102 and the radio access network 104 include, but are not limited to, analog and/or digital RF signals (i.e., radio waves) for any type of communications mode, including text messaging, multimedia messaging, voice calling, and Internet browsing. The radio access network can support various different RF communications protocols, including without limitation, GSM, UMTS, CDMA, WiMax and communications protocols as defined by 3GPP, 3GPP2, or IEEE 802.16. Although some wireless communications protocols are identified herein, it should be understood that present disclosure is not limited to the cited wireless communications protocols.

Although the content delivery system 100 depicted in FIG. 1 includes the wireless device 102 and the radio access network 104, in other embodiments, the content delivery system includes a wired device instead of the wireless device and a wired communications network instead of the radio access network. The wired device may be a wired communications device that is configured to request content from the content source 116 on behalf of a user and to render received content for presenting to the user. The wired communications network may be a wired access network such as a dial-up, digital subscriber line (DSL), or cable modem based ISP network or a private enterprise network. The wired communications network facilitates communications between the wired communications device and the core network that includes the data gateway 106, the transcoding broker 108, the Internet gateway 110, the Internet 112 that includes the transcoding system 114, and the content source 116. The wired device may be, for example, a computer equipped with an Ethernet card and the wired communications network may be an Ethernet local area network (LAN). In some embodiments, the content delivery system includes a combination of at least one wireless device, at least one radio access network, at least one wired device, and at least one wired communications network.

The data gateway 106 of the access network 111 configures outgoing data access requests for use with one or more networks and configures incoming data for use by or display on the wireless device 102. As shown, the data gateway interfaces directly with the radio access network 104 and the transcoding broker 108, although other embodiments may include other intermediate functional elements. In one embodiment, the data gateway uses GPRS Tunneling Protocol (GTP) to communicate with the radio access network. Other embodiments may use other communications protocols. Other conventional operations of the data gateway are known. For example, the data gateway enables users of wireless devices to roam between cells, for example, to move between different locations within the radio access network, by tracking the wireless device's identity across the network. The data gateway may also provide authentication and data formatting functions.

The transcoding broker 108 of the access network 111 is configured to manage the delivery of content from the content source 116 to the wireless device 102 and is described in more detail below.

The Internet gateway 110 of the access network 111 provides a gateway for communications between the wireless device 102 and Internet-connected hosts and/or servers in the Internet 112, which can also be referred to as the “cloud.” The Internet gateway may include a Serving General Packet Radio Service (GPRS) Support Node (SGSN) and a Gateway GPRS Support Node (GGSN). For example, the Internet gateway can be a Wireless Application Protocol (WAP) gateway that converts the WAP protocol used by the radio access network to the HTTP protocol used by the Internet. In an embodiment, the Internet gateway enables wireless devices to access multimedia content, such as Hyper Text Markup Language (HTML), compact HTML (cHTML), and extensible HTML (xHTML), which is stored on Internet-connected hosts and/or servers.

The transcoding system 114 of the content delivery system 100 is configured to transcode content elements from the content source 116 before the content elements are provided to the wireless device 102. As shown in FIG. 1, the transcoding system includes transcoding engines 118-1 . . . 118-N. In an embodiment, each of the transcoding engines is configured to perform bit rate adjustment and/or format conversion of at least one content element. For example, a transcoding engine may change coding parameters or the coding standard of a video file and/or adjust spatial and temporal resolution of a video file. A transcoding engine may encode an encoded video file into another encoded video file of a different format or encode a non-encoded video file into an encoded video file. The data size of a transcoded video file can be smaller than, the same as, or larger than the data size of the original video file. In another example, a transcoding engine may encode a content file into an encoded file that is more secure. Each of the transcoding engines can perform bit rate adjustment and/or format conversion of one or more content elements according to characteristics of the wireless device. The characteristics of the wireless device may include hardware characteristics, such as the physical dimensions and the resolution of the wireless device display, processor and memory specifications, and software characteristics, such as supported codecs and delivery protocols of the wireless device. Although the transcoding engines are described above with respect to video content, the transcoding engines can also be used for the transcoding of other type or types of content. For example, the transcoding engines can be used to transcode non-video content such as text, webpage, image, audio, or any combination of video and non-video content.

Although the transcoding system 114 is shown in FIG. 1 as being located in the Internet 112, the transcoding system may be located in a local network and/or a private network in some embodiments. In an embodiment, the private network is an Intranet. Alternatively, the transcoding system may be located in the Internet as well as in a private network. For example, some of the transcoding engines are located in the Internet while the rest of the transcoding engines are located in the private network.

The content source 116 of the content delivery system 100 is configured to store content elements, to process requests for content elements from the wireless device 102, and to provide requested content elements to the wireless device over at least one delivery protocol. The content source may store video content elements and/or non-video content elements such as text files, webpage files, image files, audio files, or any combination thereof. The content source may serve content elements over a single transport protocol or more than one transport protocol. In an embodiment, the content source serves video content over HTTP such as HTTP-Progressive Download (HTTP-PD) or HTTP-Adaptive Streaming (HTTP-AS), Real Time Messaging Protocol (RTMP), and/or real time streaming protocol (RTSP) or other similar protocols from a content encoder (not shown) or from pre-encoded content stored in a video content database (not shown). The content source may be an HTTP server. In an embodiment, the content source belongs to a video web site, such as YouTube.com, Google Videos, Metacafe.com, and Hulu.com. Although the content delivery system is shown in FIG. 1 as including a single content source, the content delivery system may include multiple content sources in some embodiments. The multiple content sources may be distributed among different devices in a network.

The transcoding broker 108 can perform intelligent routing of content requests in order to provide intelligent assigning of transcoding jobs to improve the transcoding efficiency of the content delivery system 100, to reduce network latency, and to provide a better user experience. In an embodiment, the transcoding broker is configured to maintain a transcoding brokerage policy for the transcoding engines 118-1 . . . 118-N in the transcoding system 114, to receive a request for a content element that is stored at the content source 116, to select at least one of the transcoding engines in the transcoding system to transcode the requested content element according to the transcoding brokerage policy, and to cause the requested content element to be transcoded by the selected transcoding engine. The transcoding brokerage policy defines rules for selecting the transcoding engines. A content element may include a single content file or multiple content files. In an embodiment, a content element corresponds to a single hyperlink. The content element may be, for example, a video content element and/or a non-video content element such as a text content element, a webpage content element, an image content element, an audio content element, or any combination thereof.

In an embodiment, the transcoding broker 108 sets the transcoding brokerage policy based on the state of the transcoding system 114. Thus, the transcoding brokerage policy includes information about the state of the transcoding system. The transcoding broker selects at least one of the transcoding engines in the transcoding system to transcode a requested content element according to the transcoding brokerage policy. The state of the transcoding system is at least partially defined by a load parameter and/or a transcoding characteristic. A load parameter of the transcoding system may be at least one of: number of streams currently being processed; service availability; available queue capacity; anticipated demand; past demand; processor utilization; memory utilization; Input/output (I/O) utilization; and temperatures of the transcoding engines 118-1 . . . 118-N. By monitoring at least one load parameter, the transcoding broker can select appropriate transcoding engines in response to real-time load conditions in order to distribute transcoding jobs across the transcoding system. The transcoding characteristic of the transcoding system may be at least one of: the number of transcoding engines in the transcoding system; types of transcoding engines in the transcoding system; physical locations of the transcoding engines; service-related reservations for the transcoding engines; maximum queue capacity of the transcoding engines; devices supported by the transcoding engines; content sources that correspond to the transcoding engines; codecs supported by the transcoding engines; and metadata mapped to some of the transcoding engines. In an embodiment, the transcoding brokerage policy includes metadata associated with the content element.

Generally, not all of the transcoding engines 118-1 . . . 118-N in the transcoding system 114 support all media conversions. In other words, each transcoding engine may only be capable of transcoding selected types of content. However, by monitoring the capabilities of the transcoding engines, the transcoding broker 108 can select a transcoding engine that can transcode the type of content element that is identified in a request.

In an embodiment, the transcoding broker 108 adjusts the transcoding brokerage policy in response to changes in the state of the transcoding system 114. By adjusting the transcoding brokerage policy as the state of the transcoding system changes, the transcoding broker can perform intelligent routing of content requests based on the current state of the transcoding system to optimize the transcoding system's performance. The optimization can be viewed from the perspective of a single transcoding engine and/or from the perspective of a group of transcoding engines.

The transcoding broker 108 allows additional computing power to be dynamically added to the transcoding engines 118-1 . . . 118-N by simply updating the transcoding brokerage policy to reflect the additional computer power. Likewise, the transcoding broker can update the transcoding brokerage policy to reflect a decrease in computing power. By updating the transcoding brokerage policy in response to changes in the state of the transcoding system 114, the transcoding broker allows the transcoding system to adapt to changing conditions. For example, it is easy to add additional transcoding engines to handle peak hour content transcoding by simply adjusting the policy of the transcoding broker. Thus, a service provider can adapt to changes in demand without having to maintain an excess pool of transcoding engines. As a result, the total cost of ownership (TCO) of the service provider can be reduced.

Although the transcoding broker 108 is shown in FIG. 1 as being located between the data gateway 106 and the Internet gateway 110, the transcoding broker can be located anywhere within the content delivery system 100. In an embodiment, the transcoding broker is located within the access network 111. By including transcoding broker in the access network, the operator of the access network, especially a wireless service provider, can better control the transcoding traffic, improve transcoding efficiency, reduce network latency, and provide better user experiences. In addition, the transcoding broker can be located in a single device or distributed amongst multiple devices. In an embodiment, the transcoding broker is located anywhere in the data path between the wireless device 102 and the content source 116. For example, the transcoding broker may be located between the radio access network and the data gateway, between the Internet gateway and the Internet 112, and/or between the Internet and the content source. In another embodiment, the transcoding broker is integrated within or located within at least one component of the content delivery system. The transcoding broker may even be integrated within the wireless device, the radio access network, the data gateway, the Internet gateway, and/or the content source, or located within the Internet. For example, the transcoding broker can be integrated within a content browser or other application program of the wireless device. The content browser may be a web browser such as Mozilla Firefox, Microsoft Internet Explorer (IE), Google Chrome, or Apple Safari. In another example, the transcoding broker is integrated within a base station or a data center in the radio access network of a wireless carrier. In yet another example, the transcoding broker is integrated within the Internet gateway of a wireless ISP or a wired ISP.

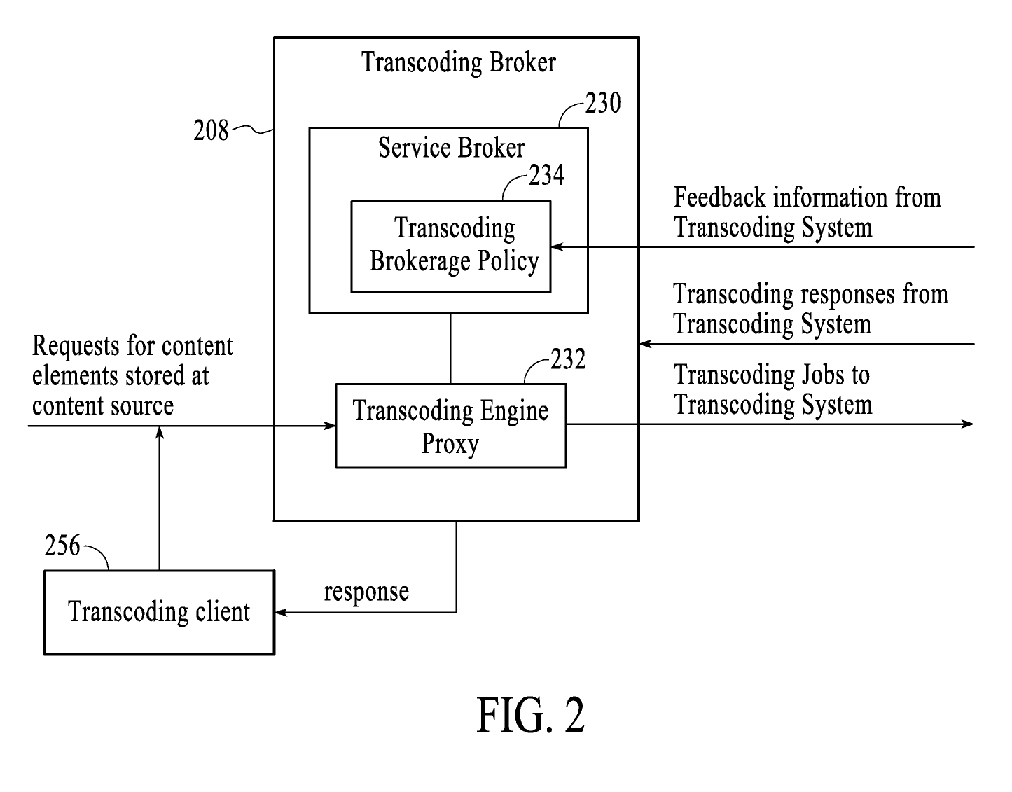

FIG. 2 depicts an embodiment of the transcoding broker 108 of FIG. 1 that includes a service broker 230 and a transcoding engine proxy 232. The transcoding broker 208 may be configured for parallel processing. For example, the transcoding broker 208 can schedule transcoding jobs to be performed in parallel, collect responses from all of the parallel transcoding jobs, and can compose a response to send to a transcoding client 256. In an embodiment, a transcoding client is a relay device that interacts with the transcoding broker 108 or 208 on behalf of an end-user device, such as the wireless device 102. The transcoding client may be located in a component of the access network 111. For example, the transcoding client may be located in the radio access network 104, the data gateway 106, or the Internet gateway 110. Alternatively, the transcoding client may be located outside of the access network. For example, the transcoding client may be located in the Internet 112. Compared with sequentially processing transcoding jobs, parallel processing of transcoding jobs can reduce the overall time required to complete multiple transcoding jobs. Although the transcoding broker 208 is depicted and described with certain components and functionality, other embodiments of the transcoding broker may include fewer or more components to implement less or more functionality. For example, the transcoding broker 208 may include more than one service broker and each service broker is responsible for a specific group of transcoding engines in the transcoding system 114. In an embodiment, components of the transcoding broker 208 are distributed among different devices in a network. For example, the service broker and the transcoding engine proxy can be located in separate network devices and/or separate networks.

The service broker 230 of the transcoding broker 208 is configured to maintain a transcoding brokerage policy 234 for the transcoding engines 118- . . . 118-N in the transcoding system 114 and to select at least one of the transcoding engines in the transcoding system to transcode the requested content element according to the transcoding brokerage policy. The transcoding engine proxy 232 of the transcoding broker 208 is configured to receive a request for a content element that is stored at the content source 116, which may be sent from the transcoding client 256, and to cause the requested content element to be transcoded by the selected transcoding engine. In some embodiments, instead of the service broker, the transcoding engine proxy selects at least one of the transcoding engines in the transcoding system to transcode the requested content element according to the transcoding brokerage policy.

The transcoding brokerage policy 234 defines rules for selecting the transcoding engines 118- . . . 118-N in the transcoding system 114. The service broker 230 sets the transcoding brokerage policy based on the state of the transcoding system. For example, the service broker may include an analytics engine that consumes real time performance metrics from the transcoding engines in the transcoding system. In the embodiment depicted in FIG. 2, the service broker receives feedback information, e.g., load parameters and/or transcoding characteristics, from the transcoding engines and adjusts the transcoding brokerage policy according to the feedback information.

In an embodiment, the service broker 230 selects at least one of the transcoding engines 118- . . . 118-N to transcode a requested content element based on the content source 116 that the request content element is stored. For example, the service broker may select the same transcoding engine(s) for all of requests for video clips that are located at a video website, such as YouTube.com. In another embodiment, the service broker selects at least one of the transcoding engines to transcode a requested content element based on the wireless device that sends out the request for the content element. For example, the service broker may select the same transcoding engine(s) for all of video clips that are requested by a particular kind of device, such as an iPhone. In another embodiment, the transcoding brokerage policy contains information related to metadata associated with the content element. The service broker selects at least one of the transcoding engines to transcode a requested content element based on the metadata associated with the content element. The metadata associated with a content element may include, for example, one or more Exchangeable image file format (Exif) tags, ID3 tags, and MediaInfo tags. An ID3 tag is a metadata container for an audio file in MP3 or other audio file format that allows audio file information such as the title, artist, album, track number to be stored in the audio file. A MediaInfo tag is a metadata container for a video file. For example, the service broker may select the same transcoding engine(s) for all of requests for video clips with high definition (HD) tags. The metadata associated with a content element may also include, for example, user location and subscriber plan. For example, the service broker may select the same transcoding engine(s) for all of media files that are requested by customers with gold subscription plans.

In an embodiment, the service broker 230 updates the transcoding brokerage policy 234 to account for the addition of one or more transcoding engines and/or to account for the loss of one or more transcoding engines. The service broker may receive requests or instructions for adding or deleting transcoding engine(s) from at least one of the components 102, 104, 106, 108, 110, 112, 114, 116, 118-1 . . . 118-N of the content delivery system 100. For example, the service broker may receive requests or instructions for adding or deleting transcoding engine(s) from the transcoding system 114 as part of the feedback information. In another example, the service broker may receive requests or instructions to add or delete transcoding engine(s) from the content source 116.

In the embodiment depicted in FIG. 2, the transcoding engine proxy 232 receives multiple requests for content elements that are stored at the content source 116 and places the received requests into a queue. By establishing a request queue, the transcoding engine proxy can defer the processing of requests to allow throttling of the transcoding engines. Using throttling, the transcoding engines can be triggered to transcode requested content elements in the queue when the transcoding engines are not busy. For example, the transcoding engine proxy may receive a request for a first content element and a request for a second content element. The transcoding engine proxy may select a second transcoding engine to transcode the second content element after selecting one of the transcoding engines to transcode the first content element. In another example, the transcoding engine proxy may select transcoding engines according to the transcoding brokerage policy 234 based on a load parameter, for example, the CPU and memory IO utilization on each transcoding engine, to evenly distribute the requests across the transcoding engines.

In the embodiment depicted in FIG. 2, the transcoding engine proxy 232 generates transcoding jobs in response to requests for content elements and assigns the generated transcoding jobs to the transcoding engines 118-1 . . . 118-N according to the transcoding brokerage policy 234. A transcoding job is an order to transcode one or more requested content elements that are stored in the content source 116. The transcoding brokerage policy may contain information that indicates that the transcoding engines in the transcoding system are divided into multiple groups of transcoding engines. Each group of transcoding engines includes one or more transcoding engines while at least one group of transcoding engines includes more than one transcoding engines. According to the transcoding brokerage policy, the transcoding engine proxy assigns transcoding jobs to the groups of transcoding engines.

In an exemplary operation of the transcoding broker 208, the states of the transcoding engines 118-1 . . . 118-N are stored in the service broker 230 and transcoding requests are received at the transcoding engine proxy 232. Transcoding engines are selected by the transcoding engine proxy based on the types of content elements identified in the requests and the selections are routed to the corresponding transcoding engines. Transcoding requests might get deferred in a queue based on the policies. In an embodiment, performance statistics for the transcoding engines are regularly transmitted to the service broker. By intelligent and informative routing, deferred transcoding, and tracking the performances of the transcoding engines, the transcoding broker enables an optimal usage of the computing power of all of the transcoding engines in the transcoding system.

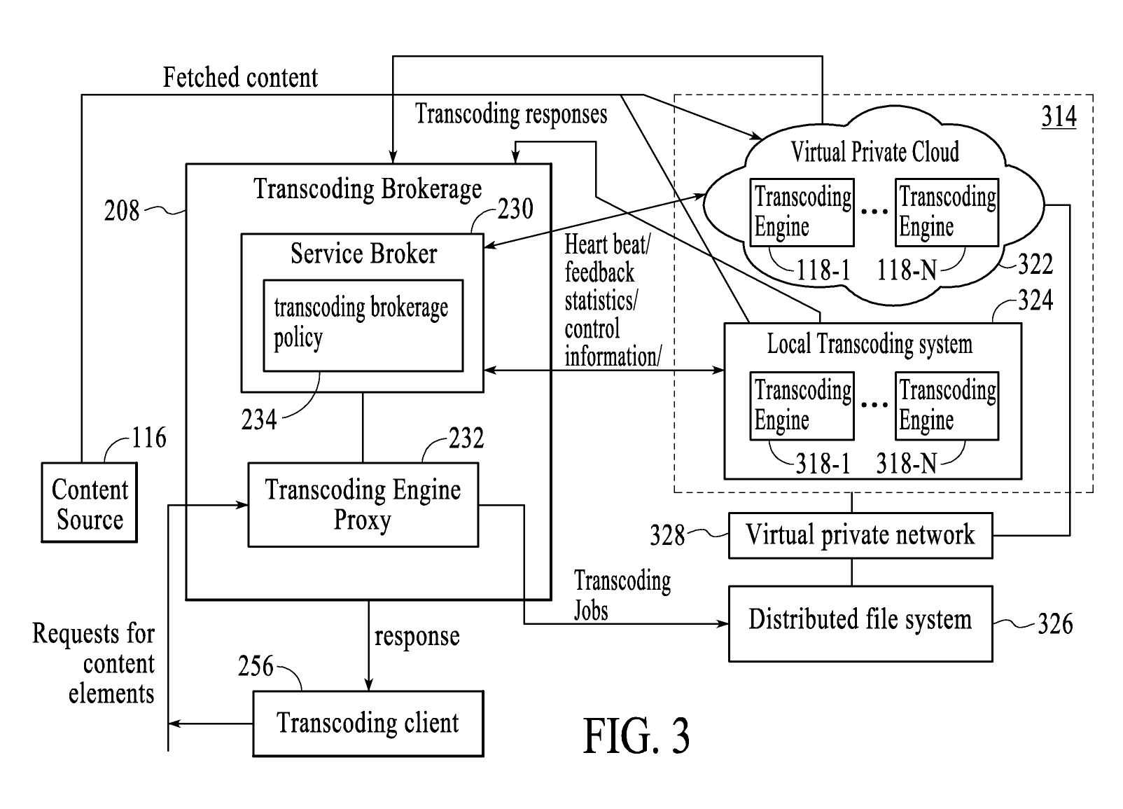

A hybrid transcoding infrastructure can be used to perform the transcoding of content elements. FIG. 3 depicts an embodiment of a hybrid transcoding infrastructure 314 with the transcoding broker 208 and the content source 116. The hybrid transcoding infrastructure includes a cloud based transcoding system 322 that includes the transcoding engines 118- . . . 118-N, and a local transcoding system 324 that includes transcoding engines 318- . . . 318-N. The cloud based transcoding infrastructure is also referred to as a virtual private cloud. The local transcoding system may be located in the same network as the transcoding broker and/or the content source. In an embodiment, the local transcoding system is implemented first and the cloud based transcoding infrastructure is added later. In this embodiment, the service broker 230 adjusts the transcoding brokerage policy 234 to include information about the transcoding engines in the Internet. The transcoding engine proxy 232 generates transcoding jobs in response to requests for content elements, which may be transmitted from the transcoding client 256, and transmits transcoding jobs to a distributed file system 326. The distributed file system sets up message queues for transcoding engines and sends transcoding messages to a virtual private network (VPN) 328. The VPN transmits the transcoding messages to the transcoding engines in the local transcoding system and the virtual private cloud. The transcoding engines in the local transcoding system and the virtual private cloud transmit transcoding responses to the transcoding engine proxy. In the embodiment depicted in FIG. 3, the transcoding engine proxy composes a response to the transcoding client based on the transcoding responses from the transcoding engines. In addition, the transcoding engines in the local transcoding system and the virtual private cloud exchange heart beat information that indicates the health of the transcoding engines, feedback statistics and control information with service broker 230.

The cloud based transcoding infrastructure 322 allows a cost effective and quicker deployment of the transcoding engines 118-1 . . . 118-N. The hosting of transcoding engines on the cloud can be based on need. Compared to hosting the transcoding engines locally, hosting the transcoding engines in the cloud can save hardware investments. Typically in festive seasons with the increasing transcoding request traffic, there is a need for additional computing power. Generally, the transcoding request traffic patterns are predictive and are bursty in nature. Thus, the cloud based transcoding infrastructure can be planned to be setup and used for a specific time period to offload the transcoding jobs. In an embodiment, transcoding latency and/or state of busyness, such as CPU utilization, of the local transcoding infrastructure is observed. By offloading the transcoding jobs to the cloud based transcoding infrastructure, the optimal load on the local transcoding infrastructure 324 can be maintained. In addition, the optimal service processing time and the user experience can be maintained even under increasing transcoding requests traffic, which can help to increase customer loyalty. Furthermore, the cloud based transcoding infrastructure can increase transcoding service throughout and be scaled quicker than the local transcoding infrastructure.

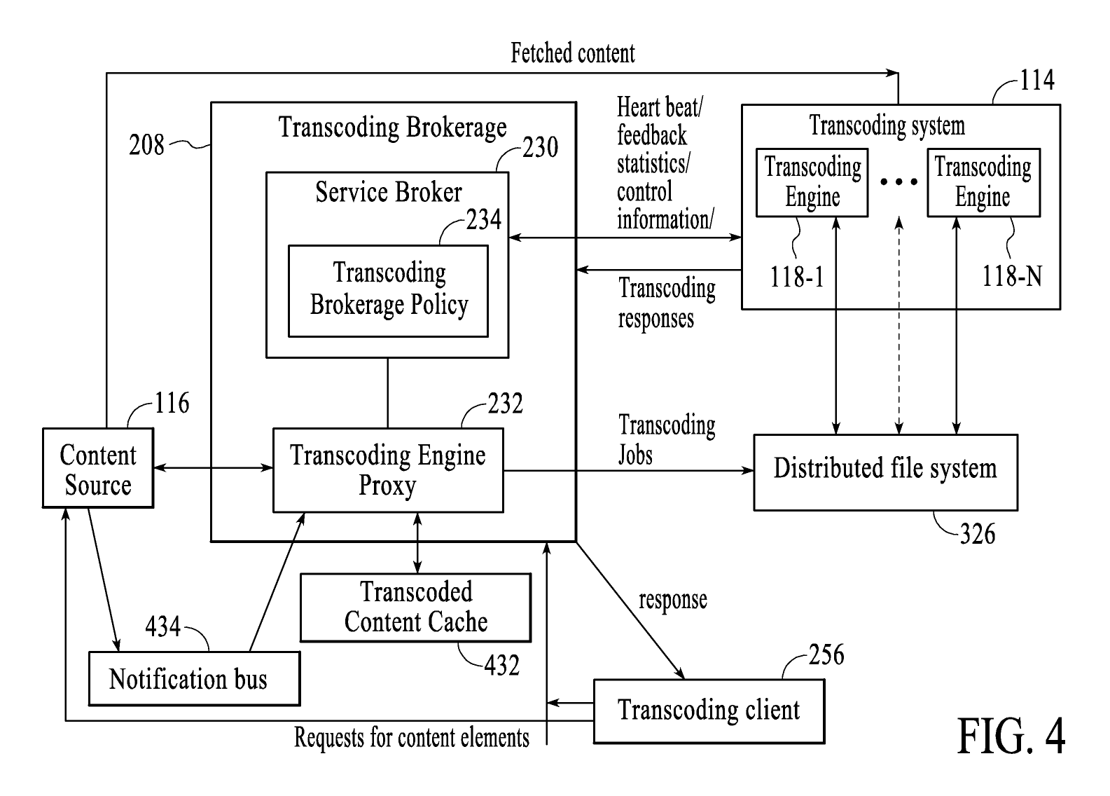

FIG. 4 illustrates interactions between the transcoding broker 208 of FIG. 2 and the transcoding system 108 and the content source 116 of FIG. 1 . . . As illustrated in FIG. 4, the transcoding engine proxy 232 transmits generates transcoding jobs in response to requests for content elements, which may be transmitted from the transcoding client 256, and transcoding jobs to the distributed file system 326. The distributed file system sets up message queues for transcoding engines and sends transcoding messages to the transcoding system 114. The transcoding system fetches stored content elements in the content source 116. The transcoding engine proxy also checks the requested content elements with a transcoded content cache 432, which caches previously transcoded content elements. If a request content element has already been transcoded in a fashion as requested and cached into the transcoded content cache, the transcoding broker transmits the cached transcoded content element to the wireless device 102. In this case, the transcoding broker will not send out a transcoding job to the transcoding system. The transcoding engines in the transcoding system transmit transcoding responses to the transcoding engine proxy. In the embodiment depicted in FIG. 4, the transcoding engine proxy composes a response to the transcoding client based on the transcoding responses from the transcoding engines. In addition, the transcoding engines 118-1 . . . 118-N in the transcoding system exchange heart beat information, feedback statistics, and control information with the service broker 230. In the embodiment of FIG. 4, the notification bus 434 is used in offline transcoding. Specifically, in offline transcoding, when the content source receives a message, such as a Multimedia Messaging Service (MMS) message from a transcoding client 256 (shown in FIG. 2), the content source generates a trigger/notification message and transmits the trigger/notification message over the notification bus to the transcoding engine proxy. The transcoding engine proxy fetches content element metadata from the content source and issues a transcoding job to one or more of the transcoding engines 118-1 . . . 118-N, which eventually pulls the requested content element from the content source and transcodes the pulled content element.

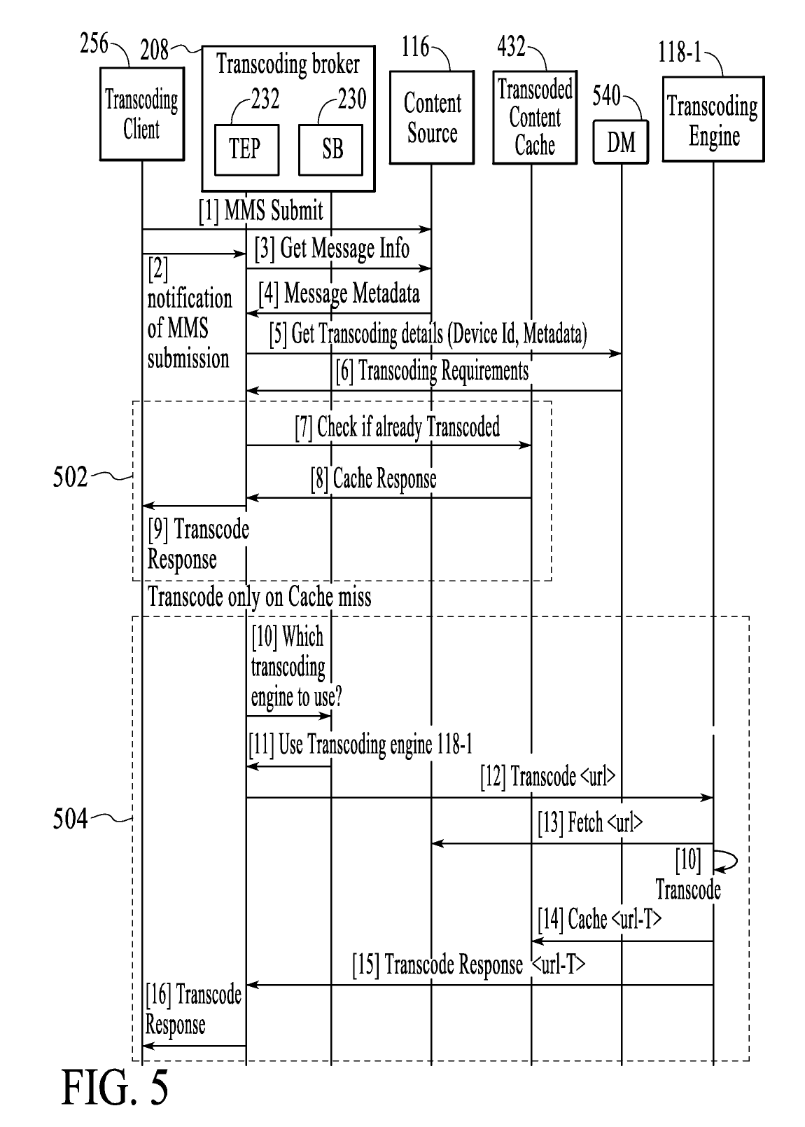

FIG. 5 illustrates an example of a real-time operation of the content delivery system of FIG. 4. In step 1, a transcoding client 256 submits an MMS message to the content source 116. In other words, the transcoding client deposits the MMS message to the content source. The MMS message contains information related to a requested content element. In step 2, the transcoding client transmits a notification of the MMS message deposition/availability to the transcoding engine proxy (TEP) 232 of the transcoding broker 208 and the transcoding engine proxy starts the transcoding procedure. In step 3, the transcoding engine proxy sends a signal or message to get the message information, which is the metadata associated with the requested content element, from the content source. In step 4, the content source transmits the message information to the transcoding engine proxy. In step 5, the transcoding engine proxy transmits a signal or message, which includes the identification (ID) information of the wireless device 102, to a device manager (DM) 540 to get the device profile of the wireless device from the device manager. The device manager is a centralized server that hosts and maintains a repository of profiles, such as User Agent Profiles, for different wireless devices. For example, the device manager may be a profile server that operates in accordance with the Wireless Universal Resource FiLe (WURFL) standard. A device profile of a wireless device is the device property file of the wireless device, which describes the device features such as supported screen size(s), supported resolution(s), supported codec(s), and supported media container/codec format(s). In step 6, the device manager derives the transcoding requirements and transmits the derived transcoding requirements to the transcoding engine proxy. Alternatively, once the device profile is available, the transcoding engine proxy can normalize two categories of information, which are content element metadata and device properties, and derive the transcoding requirements. In step 7, the transcoding engine proxy checks with the transcoded content cache to see whether or not the requested content element is already in the transcoded content cache 432. Steps 8 and 9 are the steps after the requested content element is found in the transcoded content cache. In step 8, the transcoded content cache sends the cached transcoded content element to the transcoding engine proxy. In step 9, the transcoding engine proxy sends the cached transcoded content element to the wireless device in a response. Steps 7-9 are included in block 502. Steps 10-16, which are included in block 504, are the steps after the requested content element is not found in the transcoded content cache. In step 10, the transcoding engine proxy queries the service broker (SB) for the selection of the transcoding engines in the transcoding system. The service broker may determine the selection of the transcoding engines according to the transcoding requirements. In step 11, the service broker selects the transcoding engine 118-1 according to the transcoding brokerage policy. In step 12, the transcoding engine proxy transmits a command or a message to the transcoding engine 118-1 to transcode the requested content element. In step 13, the transcoding engine 118-1 fetches the request content element from the content source and transcodes the fetched content element according to the command. In step 14, the transcoding engine 118-1 sends the transcoded content element to the transcoded content cache. In step 15, the transcoding engine 118-1 sends the transcoded content element to the transcoding engine proxy. In step 16, the transcoding engine proxy sends the transcoded content element to the transcoding client in a response.

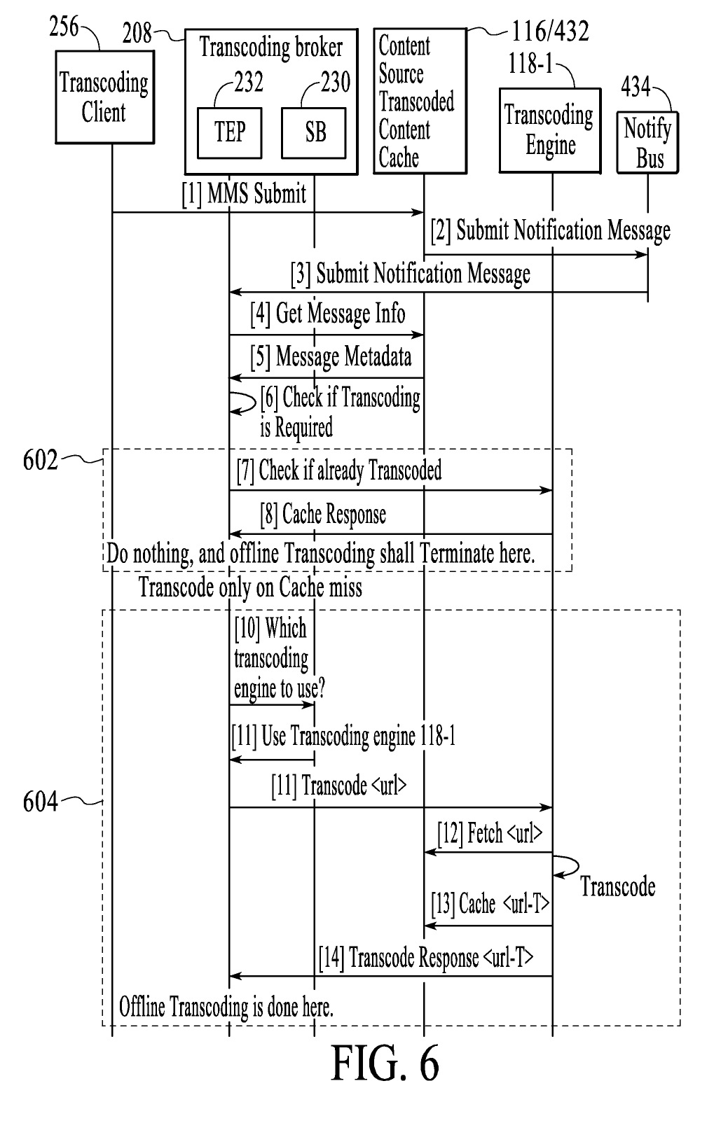

FIG. 6 illustrates an example of an offline operation of the content delivery system of FIG. 4. In step 1, a transcoding client 256 submits an MMS message to the content source 116. In other words, the transcoding client deposits the MMS message to the content source. The MMS message contains information related to a requested content element. In step 2, the content source submits a notification message to the notification bus 434, which in step 3 sends a notification to notify the transcoding engine proxy (TEP) of the transcoding broker 208 of the availability of the MMS message to start the transcoding operation. In step 4, the transcoding engine proxy sends a signal or message to get message information, which is the metadata associated with the requested content element, from the content source. In step 5, the content source transmits the message information to the transcoding engine proxy. In step 6, the transcoding engine proxy checks whether or not a transcoding operation is required. For example, the transcoding engine proxy may receive transcoding requirements that are derived by a device manager as described above with respect to FIG. 5 and determine whether or not a transcoding operation is required based on the received transcoding requirements. Alternatively, the transcoding engine proxy may derive transcoding requirements by itself and determine whether or not a transcoding operation is required based on the derived transcoding requirements. In step 7, the transcoding engine proxy checks with the transcoded content cache 432 to see whether or not the requested content element is already in the transcoded content cache. In step 8, the transcoded content cache sends the cached transcoded content element to the transcoding engine proxy. Steps 7 and 8 are included in block 602. Steps 9-14, which are included in block 604, are the steps after the requested content element is not found in the transcoded content cache. In step 9, the transcoding engine proxy queries the service broker (SB) for the selection of the transcoding engines in the transcoding system. In step 10, the service broker selects the transcoding engine 118-1 according to the transcoding brokerage policy. In step 11, the transcoding engine proxy transmits a command to the transcoding engine 118-1 to transcode the requested content element. In step 12, the transcoding engine 118-1 fetches the request content element from the content source and transcodes the fetched content element according to the command. In step 13, the transcoding engine 118-1 sends the transcoded content element to the transcoded content cache. In step 14, the transcoding engine 118-1 sends the transcoded content element to the transcoding engine proxy.

Although the operations herein are shown and described in a particular order, the order of the operations may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations may be implemented using software instructions stored on a computer useable storage medium for execution by a computer. As an example, an embodiment of a computer program product includes a computer useable storage medium to store a computer readable program that, when executed on a computer, causes the computer to perform operations, as described herein.

Furthermore, embodiments of at least portions of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

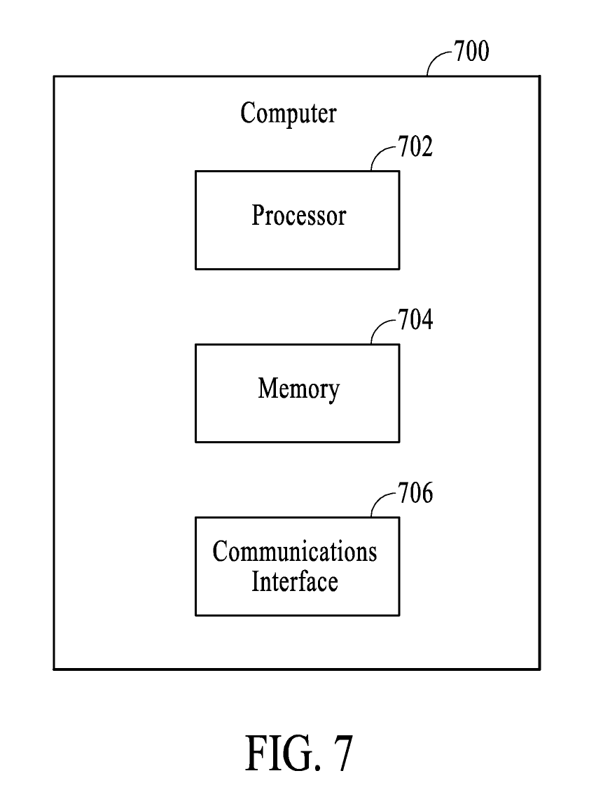

In an embodiment, at least one of the functionalities of components of the content delivery system 100, such as the transcoding broker 108 of FIG. 1 and the transcoding broker 208 of FIG. 2, is performed by a computer that executes computer readable instructions. FIG. 7 depicts a computer 700 that includes a processor 702, memory 704, and a communications interface 706. The processor may include a multifunction processor and/or an application-specific processor. Examples of processors include the PowerPC™ family of processors by IBM and the x86 family of processors by Intel. The memory within the computer may include, for example, storage medium such as read only memory (ROM), flash memory, RAM, and a large capacity permanent storage device such as a hard disk drive. The communications interface enables communications with other computers via, for example, the Internet Protocol (IP). The computer executes computer readable instructions stored in the storage medium to implement various tasks as described above.

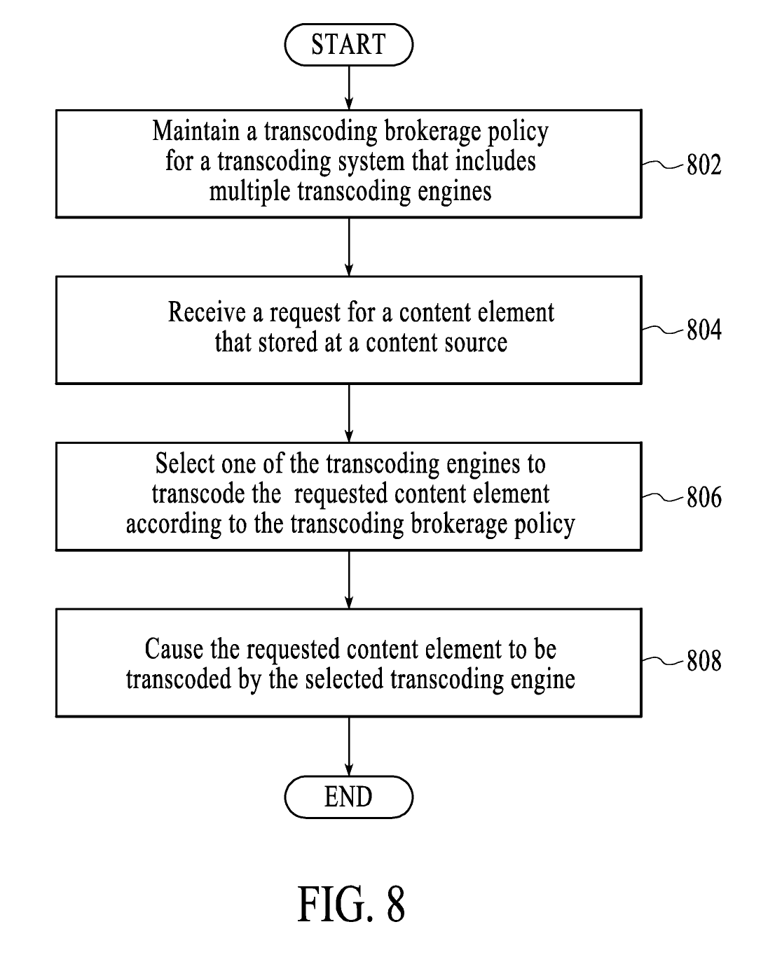

FIG. 8 is a process flow diagram of a method for managing the delivery of content over a content network in accordance with an embodiment of the invention. At block 802, a transcoding brokerage policy is maintained for a transcoding system that includes multiple transcoding engines, where the transcoding brokerage policy defines rules for selecting the transcoding engines. At block 804, a request for a content element that is stored at a content source is received. At block 806, one of the transcoding engines is selected to transcode the requested content element according to the transcoding brokerage policy. At block 808, the requested content element is caused to be transcoded by the selected transcoding engine.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for managing the delivery of content over a content network, the method comprising:
maintaining a transcoding brokerage policy for a transcoding system that includes a plurality of transcoding engines, wherein the transcoding brokerage policy defines rules for selecting the transcoding engines;
receiving a request for a content element that is stored at a content source;
selecting one of the transcoding engines to transcode the requested content element according to the transcoding brokerage policy; and
causing the requested content element to be transcoded by the selected transcoding engine.

2. The method of claim 1, wherein maintaining the transcoding brokerage policy comprises setting the transcoding brokerage policy based on the state of the transcoding system.

3. The method of claim 2, wherein the state of the transcoding system is at least partially defined by a load parameter, and wherein the load parameter is one of:
number of streams currently being processed;
service availability;
available queue capacity;
anticipated demand;
past demand;
processor utilization;
memory utilization;
input/output utilization; and
temperatures of the transcoding engines.

4. The method of claim 2, wherein the state of the transcoding system is at least partially defined by a transcoding characteristic, and wherein the transcoding characteristic is one of:
number of transcoding engines in the transcoding system;
types of transcoding engines in the transcoding system;
number of streams that one of the transcoding engines can handle in parallel;
physical locations of the transcoding engines;
service-related reservations for the transcoding engines;
maximum queue capacity of the transcoding engines;
devices supported by the transcoding engines;
codecs supported by the transcoding engines;
content sources that correspond to the transcoding engines; and
metadata mapped to some of the transcoding engines.

5. The method of claim 2, wherein maintaining the transcoding brokerage policy further comprises adjusting the transcoding brokerage policy in response to a change in the state of the transcoding system.

6. The method of claim 5, wherein the change in the state of the transcoding system is communicated from at least one of the transcoding engines as feedback information.

7. The method of claim 1, wherein the transcoding brokerage policy comprises metadata associated with the content element.

8. The method of claim 1 further comprising:
receiving a second request for a second content element that is stored at the content source;
placing the request and the second request into a queue; and
selecting another one of the transcoding engines to transcode the requested second content element according to the transcoding brokerage policy after one of the transcoding engines is selected to transcode the requested content element.

9. The method of claim 1 further comprising:
receiving subsequent requests for content elements stored in the content source;
placing the subsequent requests into a queue; and
selecting some of the transcoding engines to transcode the requested content elements according to the transcoding brokerage policy to evenly distribute the subsequent requests across the transcoding engines.

10. The method of claim 1, wherein maintaining the transcoding brokerage policy comprises adjusting the transcoding brokerage policy to include information about an additional transcoding engine.

11. A transcoding broker for managing the delivery of content over a content network, the transcoding broker comprising:
a transcoding engine proxy configured to receive a request for a content element that is stored at a content source; and
a service broker configured to:
maintain a transcoding brokerage policy for a transcoding system that includes a plurality of transcoding engines, wherein the transcoding brokerage policy defines rules for selecting the transcoding engines; and
select one of the transcoding engines to transcode the requested content element according to the transcoding brokerage policy,
wherein the transcoding engine proxy is further configured to cause the requested content element to be transcoded by the selected transcoding engine.

12. The transcoding broker of claim 11, wherein the service broker is further configured to set the transcoding brokerage policy based on the state of the transcoding system and to adjust the transcoding brokerage policy in response to a change in the state of the transcoding system, and wherein the change in the state of the transcoding system is communicated from at least one of the transcoding engines as feedback information.

13. The transcoding broker of claim 12, wherein the state of the transcoding system is at least partially defined by a load parameter, and wherein the load parameter is one of:
number of streams currently being processed;
service availability;
available queue capacity;
anticipated demand;
past demand;
processor utilization;
memory utilization;
input/output utilization; and
temperatures of the transcoding engines.

14. The transcoding broker of claim 12, wherein the state of the transcoding system is at least partially defined by a transcoding characteristic, and wherein the transcoding characteristic is one of:
number of transcoding engines in the transcoding system;
types of transcoding engines in the transcoding system;
number of streams that one of the transcoding engines can handle in parallel;
physical locations of the transcoding engines;
service-related reservations for the transcoding engines;
maximum queue capacity of the transcoding engines;
devices supported by the transcoding engines;
codecs supported by the transcoding engines;
content sources that correspond to the transcoding engines; and
metadata mapped to some of the transcoding engines.

15. The transcoding broker of claim 11, wherein the transcoding brokerage policy comprises metadata associated with the content element.

16. A method for managing the delivery of video content over a content network, the method comprising:
maintaining a transcoding brokerage policy for a transcoding system that includes a plurality of transcoding engines, wherein the transcoding brokerage policy defines rules for selecting the transcoding engines, wherein maintaining the transcoding brokerage policy comprises:
setting the transcoding brokerage policy based on the state of the transcoding system; and
adjusting the transcoding brokerage policy in response to a change in the state of the transcoding system, wherein the change in the state of the transcoding system is communicated from at least one of the transcoding engines as feedback information;
receiving a request for a video content element that is stored at a content source;
selecting one of the transcoding engines to transcode the requested video content element according to the transcoding brokerage policy; and
causing the requested video content element to be transcoded by the selected transcoding engine.

17. The method of claim 16, wherein the state of the transcoding system is at least partially defined by a load parameter, and wherein the load parameter is one of:
number of streams currently being processed;
service availability;
available queue capacity;
anticipated demand;
past demand;
processor utilization;
memory utilization;
input/output utilization; and
temperatures of the transcoding engines.

18. The method of claim 16, wherein the state of the transcoding system is at least partially defined by a transcoding characteristic, and wherein the transcoding characteristic is one of:
number of transcoding engines in the transcoding system;
types of transcoding engines in the transcoding system;
number of streams that one of the transcoding engines can handle in parallel;
physical locations of the transcoding engines;
service-related reservations for the transcoding engines;
maximum queue capacity of the transcoding engines;
devices supported by the transcoding engines;
codecs supported by the transcoding engines;
content sources that correspond to the transcoding engines; and
metadata mapped to some of the transcoding engines.

19. The method of claim 16, wherein the transcoding brokerage policy comprises metadata associated with the content element.

20. The method of claim 16 further comprising:
receiving subsequent requests for video content elements stored in the content source;
placing the subsequent requests into a queue; and
selecting some of the transcoding engines to transcode the requested video content elements according to the transcoding brokerage policy to evenly distribute the subsequent requests across the transcoding engines.
